(19) United States
(12) Patent Application Publication
(10) Pub. No.: US 2025/0377565 A1
(43) Pub. Date: Dec. 11, 2025

(54) DISPLAY DEVICE

(71) Applicant: Japan Display Inc., Tokyo (JP)

(72) Inventor: Junji KOBASHI, Tokyo (JP)

(21) Appl. No.: 19/225,614

(22) Filed: Jun. 2, 2025

(30) Foreign Application Priority Data
Jun. 5, 2024 (JP) 2024-091650

(51) Int. Cl. G02F 1/1335; G02F 1/1334

(52) U.S. Cl. CPC G02F 1/133616; G02F 1/1334

(57) ABSTRACT

According to an aspect, a display device includes: a display panel including a first light-transmitting substrate, a second light-transmitting substrate, and a liquid crystal layer and having an active area and a peripheral area; a light-transmitting glass base member bonded to the display panel; a light source; and a light source control circuit. The light source includes light emitters arranged in a first direction. The light source control circuit is configured to bring at least one of the light emitters in a first area into a light-emitting state and bring at least one of the light emitters in a second area other than the first area into a non-light-emitting state, and the first area is an area that overlaps an area obtained by extending an image area including an image in the active area in a second direction orthogonal to the first direction.

### CROSS-REFERENCE TO RELATED APPLICATION

This application claims the benefit of priority from Japanese Patent Application No. 2024-091650 filed on Jun. 5, 2024, the entire contents of which are incorporated herein by reference.

### BACKGROUND

### 1. Technical Field

What is disclosed herein relates to a display device.

### 2. Description of the Related Art

Japanese Patent Application Laid-open Publication No. 2018-021974 (JP-A-2018-021974) describes a display device that includes a first light-transmitting substrate, a second light-transmitting substrate disposed so as to face the first light-transmitting substrate, a liquid crystal layer including polymer-dispersed liquid crystals enclosed between the first and the second light-transmitting substrates, and at least one light emitter disposed so as to face at least one of side surfaces of the first and the second light-transmitting substrates.

In the display device described in JP-A-2018-021974, a viewer on one surface side of a display panel can view a background on the other surface side opposite to the one surface side through a portion in which no image is displayed. Light from a sidelight device propagates also to a see-through portion of a display area, and an image portion is desired to have higher contrast with respect to the see-through portion.

For the foregoing reasons, there is a need for a display device that increases the contrast of an image portion with respect to a see-through portion.

### SUMMARY

According to an aspect, a display device includes: a display panel that includes a first light-transmitting substrate, a second light-transmitting substrate, and a liquid crystal layer between the first light-transmitting substrate and the second light-transmitting substrate, and has an active area capable of displaying images and a peripheral area outside the active area as viewed in a direction orthogonal to the first light-transmitting substrate; a light-transmitting glass base member bonded to the display panel; a light source disposed so as to emit light into a side surface of the first light-transmitting substrate, a side surface of the second light-transmitting substrate, or a side surface of the glass base member; and a light source control circuit configured to control the light source. The light source includes a plurality of light emitters arranged in a first direction along the side surface of the first light-transmitting substrate, the side surface of the second light-transmitting substrate, or the side surface of the glass base member. The light source control circuit is configured to bring at least one of the light emitters in a first area into a light-emitting state and bring at least one of the light emitters in a second area other than the first area into a non-light-emitting state, and the first area is an area that overlaps an area obtained by extending an image area including an image in the active area in a second direction orthogonal to the first direction.

### BRIEF DESCRIPTION OF THE DRAWINGS

FIG. 1 is a perspective view illustrating an example of a display device according to an embodiment of the present disclosure;

FIG. 2 is a block diagram illustrating the display device according to a first embodiment of the present disclosure;

FIG. 3 is a timing diagram explaining timing of light emission by a light source in a field-sequential system of the first embodiment;

FIG. 4 is an explanatory diagram illustrating a relation between a voltage applied to a pixel electrode and a scattering state of a pixel;

FIG. 5 is a sectional view illustrating an example of a section of the display device;

FIG. 6 is a plan view illustrating a planar surface of the display device of FIG. 1;

FIG. 7 is an enlarged sectional view obtained by enlarging a liquid crystal layer portion of FIG. 5;

FIG. 8 is a sectional view for explaining a non-scattering state in the liquid crystal layer;

FIG. 9 is a sectional view for explaining the scattering state in the liquid crystal layer;

FIG. 10 is a plan view illustrating scan lines, signal lines, and a switching element in the pixel;

FIG. 11 is an explanatory diagram explaining a relation between a viewer and a background, the viewer viewing the background from one surface side, the background being located on the other surface side opposite to the one surface side;

FIG. 12 is an explanatory diagram explaining an example in which a peripheral area overlaps the background;

FIG. 13A is a schematic diagram for explaining a light source of the first embodiment;

FIG. 13B is a schematic diagram for explaining the light source of the first embodiment;

FIG. 13C is a schematic diagram for explaining the light source of the first embodiment;

FIG. 14A is a schematic diagram for explaining a light source of a second embodiment of the present disclosure;

FIG. 14B is a schematic diagram for explaining the light source of the second embodiment;

FIG. 14C is a schematic diagram for explaining the light source of the second embodiment;

FIG. 15 is a plan view for explaining a light source of a third embodiment of the present disclosure;

FIG. 16 is a plan view for explaining a light source of a fourth embodiment of the present disclosure; and

FIG. 17 is a sectional view illustrating an example of a section of a light source of a fifth embodiment of the present disclosure.

### DETAILED DESCRIPTION

The following describes modes (embodiments) for carrying out the present disclosure in detail with reference to the drawings. The present disclosure is not limited to the description of the embodiments given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same element as that illustrated in a drawing that has already been discussed is denoted by the same reference numeral through the description and the drawings, and detailed description thereof may not be repeated where appropriate.

In this disclosure, when an element is described as being “on” another element, the element can be directly on the other element, or there can be one or more elements between the element and the other element.

### First Embodiment

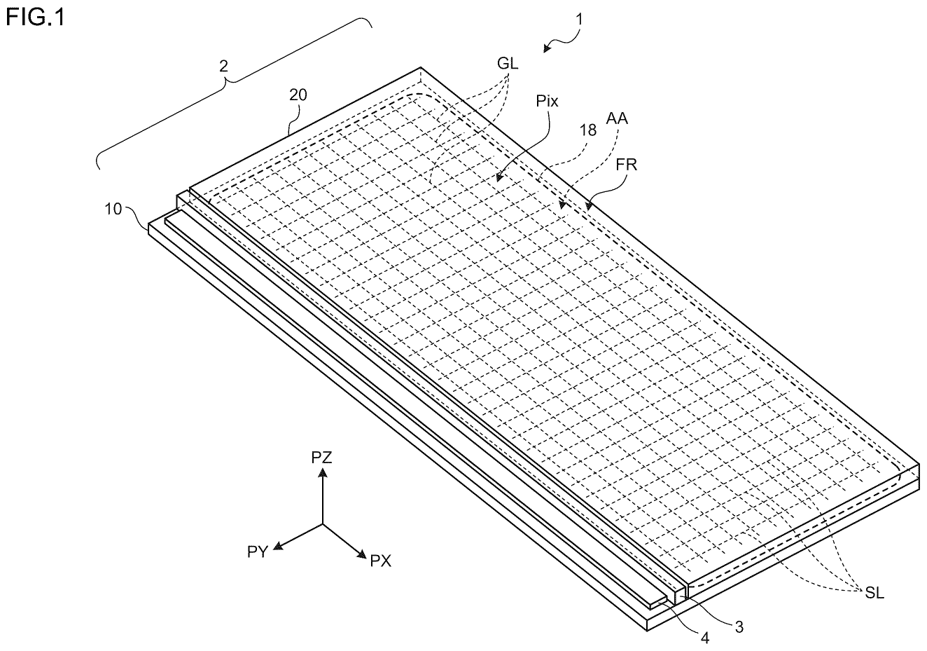

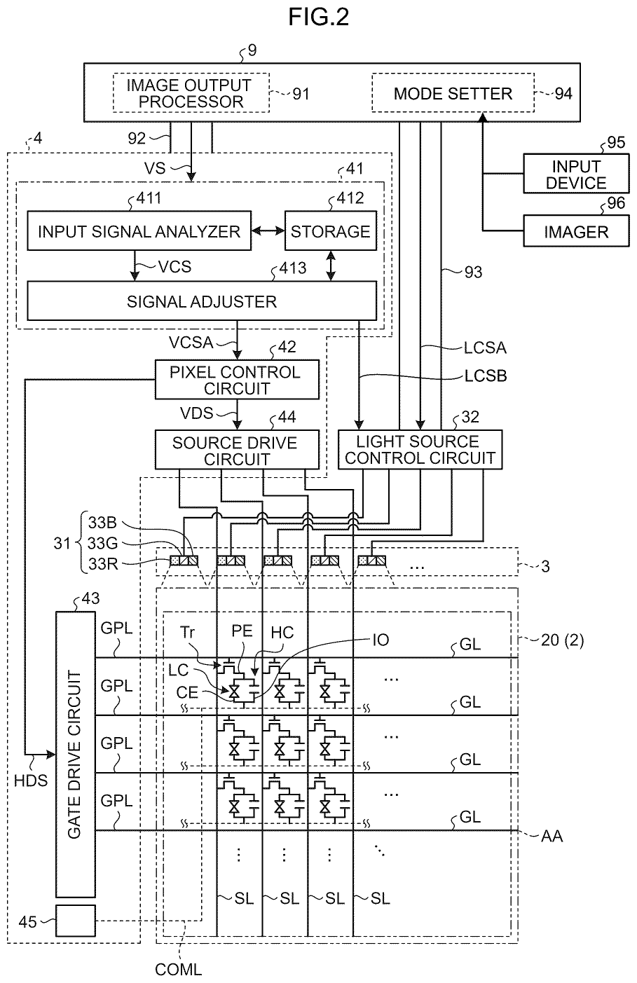

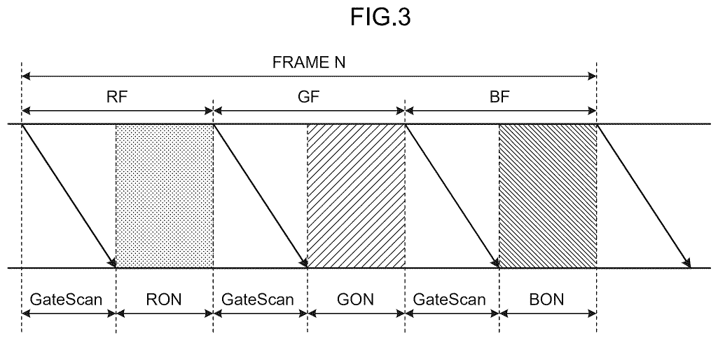

FIG. 1 is a perspective view illustrating an example of a display device according to an embodiment of the present disclosure. FIG. 2 is a block diagram illustrating the display device according to a first embodiment of the present disclosure. FIG. 3 is a timing diagram explaining timing of light emission by a light source in a field-sequential system.

As illustrated in FIG. 1, a display device 1 includes a display panel 2, a light source 7, and a drive circuit 4. A direction PX denotes one direction in the plane of the display panel 2. A second direction PY denotes a direction orthogonal to the direction PX. A third direction PZ denotes a direction orthogonal to the PX-PY plane.

A higher-level controller 9 is a computer, which includes, for example, a central processing unit (CPU), a read-only memory (ROM), a random-access memory (RAM), a storage circuit, an input interface, and an output interface. The CPU, the ROM, the RAM, and the memory circuit are coupled to one another via an internal bus. The ROM stores therein computer programs, such as Basic Input/Output System (BIOS). The storage circuit is, for example, a hard disk drive (HDD) or a flash memory, which stores therein operating system programs and application programs. The CPU performs various functions by executing computer programs stored in the ROM or a storage circuit 53 while using the RAM as a work area, and serves, for example, as an image output processor 91 and a mode setter 94.

The image output processor 91 transmits image information to the drive circuit 4 coupled thereto via a flexible printed circuit board 92.

The higher-level controller 9 is coupled to at least one of an input device 95 and an imager 96. The input device 95 is an input device, such as a keyboard and/or a mouse. The input device 95 receives information mainly on the direction in which the display panel 2 is viewed. Based on the information from the input device 95, the mode setter 94 performs mode setting about the position of a viewer, and a mode setting signal LCSA is transmitted to a light source control circuit 32. The position of the viewer set by the mode setter 94 will be described later.

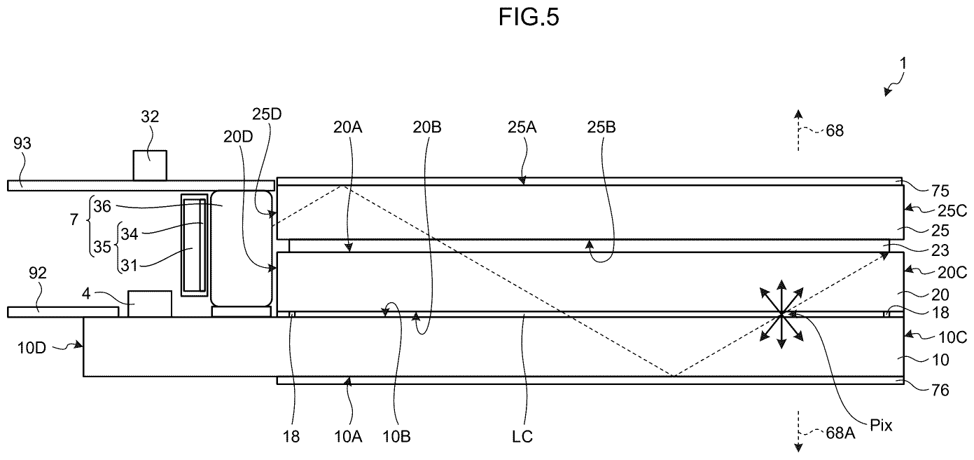

The display panel 2 includes an array substrate 10, a counter substrate 20, and a liquid crystal layer 50 (refer to FIG. 5). The array substrate 10 serves as a first light-transmitting substrate, and the counter substrate 20 serves as a second light-transmitting substrate. The counter substrate 20 faces a surface of the array substrate 10 in a direction orthogonal thereto (in the direction PZ illustrated in FIG. 1). In the liquid crystal layer 50 (refer to FIG. 5), polymer-dispersed liquid crystals LC (to be described later) are sealed by the array substrate 10, the counter substrate 20, and a sealing portion 18.

As illustrated in FIG. 1, the display panel 2 has an active area AA capable of displaying images and a peripheral area FR outside the active area AA. A plurality of pixels Pix are arranged in a matrix having a row-column configuration in the active area AA. In the present disclosure, a row refers to a pixel row including m pixels Pix arranged in one direction. In addition, a column refers to a pixel column including n pixels Pix arranged in a direction orthogonal to the direction in which the rows are arranged. The values of m and n are determined according to a display resolution in the vertical direction and a display resolution in the horizontal direction. A plurality of scan lines GL are provided corresponding to the rows, and a plurality of signal lines SL are provided corresponding to the columns.

As illustrated in FIG. 2, the light source 7 includes a plurality of light emitters 31. The light source control circuit 32 is provided on a wiring board 93. The wiring board 93 is a flexible printed circuit board or a printed circuit board (PCB). The mode setting signal LCSA is transmitted from the image output processor 91 of the external higher-level controller 9 to the light source control circuit 32. The mode setting signal LCSA will be described later.

As illustrated in FIG. 1, the drive circuit 4 is fixed to the surface of the array substrate 10. As illustrated in FIG. 2, the drive circuit 4 includes a signal processing circuit 41, a pixel control circuit 42, a gate drive circuit 43, a source drive circuit 44, and a common potential drive circuit 45. The array substrate 10 has an area in the PX-PY plane larger than that of the counter substrate 20, and the drive circuit 4 is provided on a projecting portion of the array substrate 10 exposed from the counter substrate 20.

The signal processing circuit 41 receives a first input signal (such as a red-green-blue (RGB) signal) VS from the image output processor 91 of the external higher-level controller 9 via the flexible printed circuit board 92.

The signal processing circuit 41 includes an input signal analyzer 411, a storage 412, and a signal adjuster 413. The input signal analyzer 411 generates a second input signal VCS based on the externally received first input signal VS.

The second input signal VCS is a signal for determining a gradation value to be given to each of the pixels Pix of the display panel 2 based on the first input signal VS. In other words, the second input signal VCS is a signal including gradation information on the gradation value of each of the pixels Pix.

The signal adjuster 413 generates a third input signal VCSA from the second input signal VCS. The signal adjuster 413 transmits the third input signal VCSA to the pixel control circuit 42. A light source control signal LCSB is a signal including information on light quantities of the light emitters 31 set according to, for example, input gradation values to be given to the pixels Pix. The light source control circuit 32 causes the light emitters 31 to emit light based on the mode setting signal LCSA and the light source control signal LCSB.

The pixel control circuit 42 generates a horizontal drive signal HDS and a vertical drive signal VDS based on the third input signal VCSA. In the present embodiment, since the display device 1 is driven based on the field-sequential system, the horizontal drive signal HDS and the vertical drive signal VDS are generated for each color emittable by the light emitters 31.

The gate drive circuit 43 sequentially selects the scan lines GL of the display panel 2 based on the horizontal drive signal HDS within one vertical scan period. The scan lines GL can be selected in any order. The gate drive circuit 43 is electrically coupled to the scan lines GL via second wiring GPL arranged in the peripheral area FR outside the active area AA (refer to FIG. 1).

The source drive circuit 44 supplies gradation signals corresponding to output gradation values of the pixels Pix to the signal lines SL of the display panel 2 based on the vertical drive signal VDS within one horizontal scan period.

In the present embodiment, the display panel 2 is an active matrix panel. Therefore, the display panel 2 includes the signal (source) lines SL extending in the second direction PY and the scan (gate) lines GL extending in the first direction PX in plan view, and includes switching elements Tr at intersections between the signal lines SL and the scan lines GL.

A thin-film transistor is used as each of the switching elements Tr. A bottom-gate transistor or a top-gate transistor may be used as an example of the thin-film transistor. Although a single-gate thin film transistor is exemplified as the switching element Tr, the switching element Tr may be a double-gate transistor. One of the source electrode and the drain electrode of the switching element Tr is coupled to a corresponding one of the signal lines SL. The gate electrode of the switching element Tr is coupled to a corresponding one of the scan lines GL. The other of the source electrode and the drain electrode is coupled to one end of a capacitor of the polymer-dispersed liquid crystals LC to be described later. The capacitor of the polymer-dispersed liquid crystals LC is coupled at one end thereof to the switching element Tr through a pixel electrode PE, and coupled at the other end thereof to common potential wiring COML via a common electrode CE. With this configuration, the common potential is supplied to the common electrode CE. Holding capacitance HC is generated between the pixel electrode PE and a holding capacitance electrode IO electrically coupled to the common potential wiring COML. A potential of the common potential wiring COML is supplied by the common potential drive circuit 45.

Each of the light emitters 31 includes a light-emitting element 33R of a first color (such as red), a light-emitting element 33G of a second color (such as green), and a light-emitting element 33B of a third color (such as blue). The light source control circuit 32 controls the light-emitting element 33R of the first color, the light-emitting element 33G of the second color, and the light-emitting element 33B of the third color so as to emit light in a time-division manner based on the mode setting signal LCSA and the light source control signal LCSB. In this way, the light-emitting element 33R of the first color, the light-emitting element 33G of the second color, and the light-emitting element 33B of the third color are driven based on the field-sequential system.

As illustrated in FIG. 3, in a first sub-frame (first predetermined time) RF, the light-emitting element 33R of the first color emits light during a first color light emission period RON, and the pixels Pix selected during one vertical scan period GateScan scatter light to perform display. On the entire display panel 2, if the gradation signal corresponding to the output gradation value of each of the pixels Pix is supplied to the above-described signal lines SL for the pixels Pix selected during the one vertical scan period GateScan, only the first color is lit up during the first color light emission period RON.

Then, in a second sub-frame (second predetermined time) GF, the light-emitting element 33G of the second color emits light during a second color light emission period GON, and the pixels Pix selected during the one vertical scan period GateScan scatter light to perform display. On the entire display panel 2, if the gradation signal corresponding to the output gradation value of each of the pixels Pix is supplied to the above-described signal lines SL for the pixels Pix selected during the one vertical scan period GateScan, only the second color is lit up during the second color light emission period GON.

Further, in a third sub-frame (third predetermined time) BF, the light-emitting element 33B of the third color emits light during a third color light emission period BON, and the pixels Pix selected during the one vertical scan period GateScan scatter light to perform display. On the entire display panel 2, if the gradation signal corresponding to the output gradation value of each of the pixels Pix is supplied to the above-described signal lines SL for the pixels Pix selected during the one vertical scan period GateScan, only the third color is lit up during the third color light emission period BON.

Since a human eye has a limited temporal resolution and produces an afterimage, an image with a combination of three colors is recognized in a period of one frame (1F). The field-sequential system can eliminate the need for a color filter, and thus can reduce an absorption loss by the color filter. As a result, higher transmittance can be obtained. In a color filter system, one pixel is made up of sub-pixels obtained by dividing each of the pixels Pix into the sub-pixels of the first color, the second color, and the third color. In contrast, in the field-sequential system, the pixel need not be divided into the sub-pixels in such a manner. A fourth sub-frame may be further included to emit light in a fourth color different from any one of the first color, the second color, and the third color.

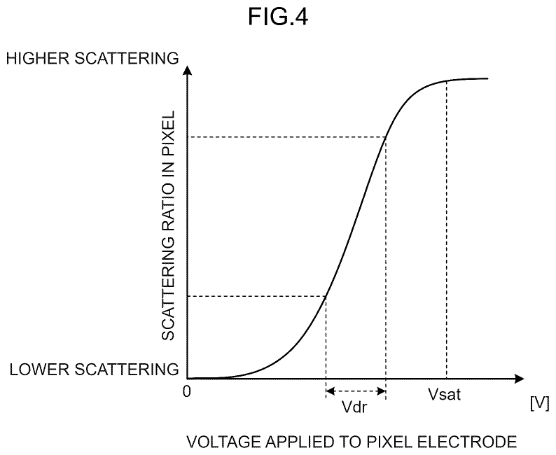

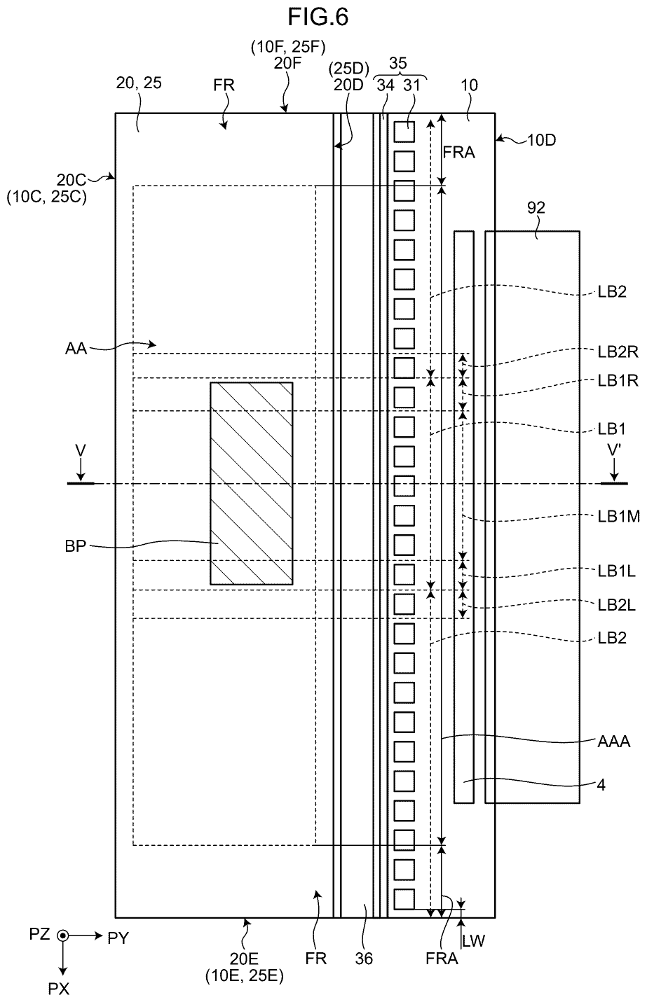

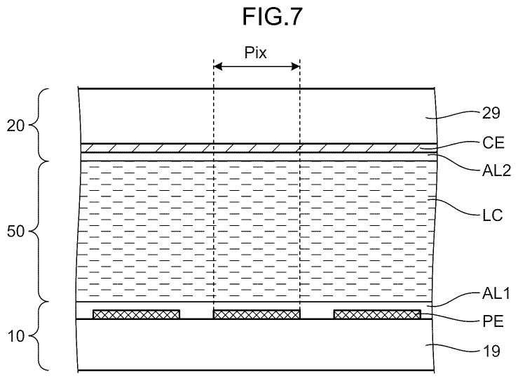

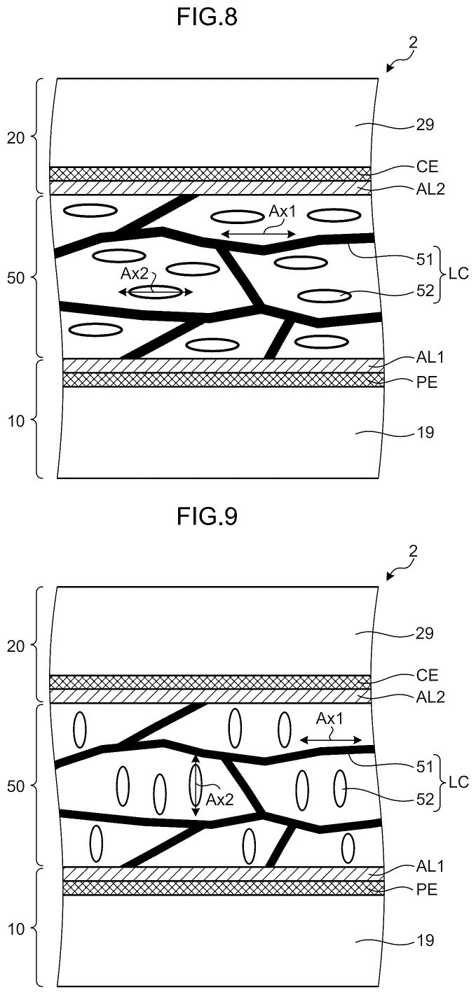

FIG. 4 is an explanatory diagram illustrating a relation between a voltage applied to the pixel electrode and a scattering state of the pixel. FIG. 5 is a sectional view illustrating an example of a section of the display device of FIG. 1. FIG. 6 is a plan view illustrating a planar surface of the display device of FIG. 1. FIG. 7 is an enlarged sectional view obtained by enlarging the liquid crystal layer portion of FIG. 5. FIG. 8 is a sectional view for explaining a non-scattering state in the liquid crystal layer. FIG. 9 is a sectional view for explaining the scattering state in the liquid crystal layer.

If the gradation signal corresponding to the output gradation value of each of the pixels Pix is supplied to the above-described signal lines SL for the pixels Pix selected during the one vertical scan period GateScan, the voltage applied to the pixel electrode PE changes with the gradation signal. The change in the voltage applied to the pixel electrode PE changes the voltage between the pixel electrode PE and the common electrode CE. The scattering state of the liquid crystal layer 50 for each of the pixels Pix is controlled according to the voltage applied to the pixel electrode PE, and the scattering ratio in the pixels Pix changes, as illustrated in FIG. 4.

As illustrated in FIG. 4, the change in the scattering ratio in the pixel Pix is smaller when the voltage applied to the pixel electrode PE is equal to or higher than a saturation voltage Vsat. Therefore, the drive circuit 4 changes the voltage applied to the pixel electrode PE according to the vertical drive signal VDS within a voltage range Vdr lower than the saturation voltage Vsat.

As illustrated in FIG. 5, the display device 1 includes a light-transmitting base member 25 and the display panel 2. A protective layer 75 is provided on one surface of the light-transmitting base member 25. A protective layer 76 is provided on one surface of the display panel 2.

The display panel 2 includes the array substrate 10, the counter substrate 20, and the liquid crystal layer 50. The counter substrate 20 faces the surface of the array substrate 10 in a direction orthogonal thereto (in the direction PZ illustrated in FIG. 1). In the liquid crystal layer 50, the polymer-dispersed liquid crystals (to be described later) are sealed by the array substrate 10, the counter substrate 20, and the sealing portion 18.

As illustrated in FIGS. 5 and 6, the array substrate 10 has a first principal surface 10A, a second principal surface 10B, a first side surface 10C, a second side surface 10D, a third side surface 10E, and a fourth side surface 10F. The first principal surface 10A and the second principal surface 10B are parallel flat surfaces. The first side surface 10C and the second side surface 10D are parallel flat surfaces. The third side surface 10E and the fourth side surface 10F are parallel flat surfaces.

As illustrated in FIGS. 5 and 6, the counter substrate 20 has a first principal surface 20A, a second principal surface 20B, a first side surface 20C, a second side surface 20D, a third side surface 20E, and a fourth side surface 20F. The first principal surface 20A and the second principal surface 20B are parallel flat surfaces. The first side surface 20C and the second side surface 20D are parallel flat surfaces. The third side surface 20E and the fourth side surface 20F are parallel flat surfaces.

The base member 25 is bonded to the first principal surface 20A of the counter substrate 20 with an optical resin 23 interposed therebetween. The base member 25 is a protective substrate for the counter substrate 20 and is formed, for example, of glass or a light-transmitting resin. When the base member 25 is formed of a glass base member, it is also called a cover glass. When the base member 25 is formed of a light-transmitting resin, it may be flexible. The same base member as the base member 25 may be bonded to the first principal surface 10A of the array substrate 10 with an optical resin interposed therebetween.

As illustrated in FIGS. 5 and 6, the base member 25 has a first principal surface 25A, a second principal surface 25B, a first side surface 25C, a second side surface 25D, a third side surface 25E, and a fourth side surface 25F. The first principal surface 25A and the second principal surface 25B are parallel flat surfaces. The first side surface 25C and the second side surface 25D are parallel flat surfaces. The third side surface 25E and the fourth side surface 25F are parallel flat surfaces.

As illustrated in FIGS. 5 and 6, the light source 7 faces the second side surface 20D of the counter substrate 20. The light source 7 may also be called a side light source. As illustrated in FIG. 5, the light source 7 emits light-source light L to the second side surface 20D of the counter substrate 20. The second side surface 20D of the counter substrate 20 facing the light source 7 serves as a plane of light incidence. The second side surface 25D of the base member 25 facing the light source 7 also serves as a plane of light incidence.

The light source 7 includes a light-emitting module 35 and a light guide 36. The light-emitting module 35 includes the light emitters 31 and an optical member 34. Each of the light emitters 31 includes the light-emitting element 33R of the first color (such as red), the light-emitting element 33G of the second color (such as green), and the light-emitting element 33B of the third color (such as blue), as illustrated in FIG. 2. The light guide 36 guides the light emitted by the light-emitting element 33R of the first color, the light-emitting element 33G of the second color, and the light-emitting element 33B of the third color, to the second side surface 20D of the counter substrate 20 and the second side surface 25D of the base member 25. The light guide 36 simultaneously receives the light from the light emitters 31, internally diffuses the received light, and emits the diffused light to the display panel 2. As a result, the light emitted to the second side surface 20D of the counter substrate 20 and the second side surface 25D of the base member 25 is uniformly distributed per unit area.

The light guide 36 is the single light guide 36 formed integrally from the third side surface 20E (or the third side surface 25E) to the fourth side surface 20F (or the fourth side surface 25F). The light guide 36 may be formed by arranging a plurality of divided light guides from the third side surface 20E (or the third side surface 25E) to the fourth side surface 20F (or the fourth side surface 25F). The light guide 36 may be formed by arranging a plurality of divided light guides from the third side surface 20E (or the third side surface 25E) to the fourth side surface 20F (or the fourth side surface 25F) and connecting the adjacent light guides to each other.

The light source 7 is mounted so as to overlap the second principal surface 10B of the array substrate 10. The following description will be made based on this embodiment, but the present disclosure is not limited to this example. The light source 7 may irradiate a side surface of the array substrate 10.

The wiring board 93 (flexible printed circuit board or PCB) is provided with an integrated circuit of the light source control circuit 32, and the light source control circuit 32 is coupled to the light source 7 via the wiring board 93 (flexible printed circuit board or PCB).

As illustrated in FIG. 5, the light-source light L emitted from the light source 7 propagates in a direction (second direction PY) away from the second side surface 20D while being reflected by the base member 25, the first principal surface 10A of the array substrate 10, and the first principal surface 20A of the counter substrate 20 or the base member 25. When the light-source light L travels outward from the first principal surface 10A of the array substrate 10 or the first principal surface 20A of the counter substrate 20, the light-source light L enters a medium having a lower refractive index from a medium having a higher refractive index. Hence, if the angle of incidence of the light-source light L incident on the first principal surface 10A of the array substrate 10 or the first principal surface 20A of the counter substrate 20 is larger than a critical angle, the light-source light L is totally reflected by the first principal surface 10A of the array substrate 10 or the first principal surface 20A of the counter substrate 20.

As illustrated in FIG. 5, the light-source light L that has propagated in the array substrate 10 and the counter substrate 20 is scattered by the pixels Pix including the liquid crystals placed in the scattering state, and the angle of incidence of the scattered light becomes an angle smaller than the critical angle. Thus, emission light 68 or 68A is emitted outward from the first principal surface 20A of the counter substrate 20 (the first principal surface 25A of the base member 25) or the first principal surface 10A of the array substrate 10, respectively. The emission light 68 or 68A emitted outward from the first principal surface 20A of the counter substrate 20 or the first principal surface 10A of the array substrate 10, respectively, is viewed by a viewer.

Therefore, as illustrated in FIG. 6, the light emitters 31 are arranged at a predetermined pitch in an active light-emitting area AAA that corresponds to the active area AA in the second direction PY. In the first embodiment, the light emitters 31 are arranged at the predetermined pitch in a peripheral light-emitting area FRA corresponding to the peripheral area FR in the second direction PY.

An image BP is displayed in all or part of the active area AA.

A distance LW from the light emitter 31 to the third side surface 20E (or fourth side surface 20F) in the first direction PX falls within a range from 0 mm to half the distance of the peripheral light-emitting area FRA. The distance LW between the light emitter 31 provided closest to the third side surface 20E (or fourth side surface 20F) and the third side surface 20E (or fourth side surface 20F) is preferably shorter.

The following describes the polymer-dispersed liquid crystals in the scattering state and the polymer-dispersed liquid crystals in the non-scattering state, using FIGS. 7 to 9.

As illustrated in FIG. 7, the array substrate 10 is provided with a first orientation film AL1. The counter substrate 20 is provided with a second orientation film AL2. When the orientation films are subjected to orientation treatment, for example, the first orientation film AL1 is oriented toward one side of the first direction PX, and the second orientation film AL2 is oriented toward the other side of the first direction PX. The first and the second orientation films AL1 and AL2 may be, for example, vertical orientation films, or may be orientation films oriented in the first direction PX in which the light emitters 31 are arranged. The orientation treatment is performed by performing rubbing treatment or photo-orientation treatment.

The polymer-dispersed liquid crystals LC of the liquid crystal layer 50 illustrated in FIG. 7 are enclosed between the array substrate 10 and the counter substrate 20. Then, in a state where the monomer and the liquid crystals are oriented by the first and the second orientation films AL1 and AL2, the monomer is polymerized by ultraviolet rays or heat to form a three-dimensional mesh-like polymer network 51. This process forms the liquid crystal layer 50 including the reverse-mode polymer-dispersed liquid crystals LC in which liquid crystal molecules 52 are dispersed in gaps of the three-dimensional mesh-like polymer network 51 formed in the mesh shape.

Thus, the polymer-dispersed liquid crystals LC include the three-dimensional mesh-like polymer network 51 and the liquid crystal molecules 52.

The orientation of the liquid crystal molecules 52 is controlled by a voltage difference between the pixel electrode PE and the common electrode CE. The voltage applied to the pixel electrode PE changes the orientation of the liquid crystal molecules 52. The degree of scattering of light passing through the pixels Pix changes with change in the orientation of the liquid crystal molecules 52.

For example, as illustrated in FIG. 8, the direction of an optical axis Ax1 of the polymer network 51 is substantially equal to the direction of an optical axis Ax2 of the liquid crystal molecules 52 when no voltage is applied between the pixel electrode PE and the common electrode CE. The optical axis Ax2 of the liquid crystal molecules 52 is parallel to the direction PX (FIG. 1) of the liquid crystal layer 50. The optical axis Ax1 of the polymer network 51 is parallel to the direction PX of the liquid crystal layer 50 regardless of whether a voltage is applied.

Ordinary-ray refractive indices of the polymer network 51 and the liquid crystal molecules 52 are equal to each other. When no voltage is applied between the pixel electrode PE and the common electrode CE, the difference in refractive index between the polymer network 51 and the liquid crystal molecules 52 is substantially zero in all directions. The liquid crystal layer 50 is placed in the non-scattering state of not scattering the light-source light. The light-source light propagates in a direction away from the light source 7 (light emitters 31). When the liquid crystal layer 50 is in the non-scattering state of not scattering the light-source light, a background on the first principal surface 20A side of the counter substrate 20 is visible from the first principal surface 10A of the array substrate 10, and a background on the first principal surface 10A side of the array substrate 10 is visible from the first principal surface 20A of the counter substrate 20.

As illustrated in FIG. 9, in the gap between the pixel electrode PE and the common electrode CE having a voltage applied thereto, the optical axis Ax2 of the liquid crystal molecules 52 is inclined by an electric field generated between the pixel electrode PE and the common electrode CE. Since the optical axis Ax1 of the polymer network 51 is not changed by the electric field, the direction of the optical axis Ax1 of the polymer network 51 differs from the direction of the optical axis Ax2 of the liquid crystal molecules 52. The light-source light is scattered in the pixel Pix including the pixel electrode PE having a voltage applied thereto. As described above, the viewer views a part of the scattered light-source light emitted outward from the first principal surface 10A of the array substrate 10 or the first principal surface 20A of the counter substrate 20.

In the pixel Pix including the pixel electrode PE having no voltage applied thereto, the background on the first principal surface 20A side of the counter substrate 20 is visible from the first principal surface 10A of the array substrate 10, and the background on the first principal surface 10A side of the array substrate 10 is visible from the first principal surface 20A of the counter substrate 20. In the display device 1 of the present embodiment, when the first input signal VS is received from the image output processor 91, the voltage is applied to the pixel electrode PE of the pixel Pix for displaying an image, and an image based on the third input signal VCSA becomes visible together with the background. Thus, the image is displayed in the display area when the polymer-dispersed liquid crystals LC are in the scattering state.

The light-source light is scattered in the pixel Pix including the pixel electrode PE having a voltage applied thereto, and emitted outward to display the image, which is displayed so as to be superimposed on the background. In other words, the display device 1 of the present embodiment can display the image so as to be superimposed on the background by combining the emission light 68 or 68A with the background.

A potential of each of the pixel electrodes PE (refer to FIG. 7) written during the one vertical scan period GateScan illustrated in FIG. 3 needs to be held during at least one of the first color light emission period RON, the second color light emission period GON, and the third color light emission period BON after each one vertical scan period GateScan. If the written potential of each of the pixel electrodes PE (refer to FIG. 7) cannot be held during at least one of the first color light emission period RON, the second color light emission period GON, and the third color light emission period BON after each one vertical scan period GateScan, what are called flickers, for example, are likely to occur. In other words, in order to shorten the one vertical scan period GateScan serving as a time for selecting the scan lines and increase the visibility in the driving based on what is called the field-sequential system, the written potential of each of the pixel electrodes PE (refer to FIG. 7) is required to be easily held during each of the first color light emission period RON, the second color light emission period GON, and the third color light emission period BON.

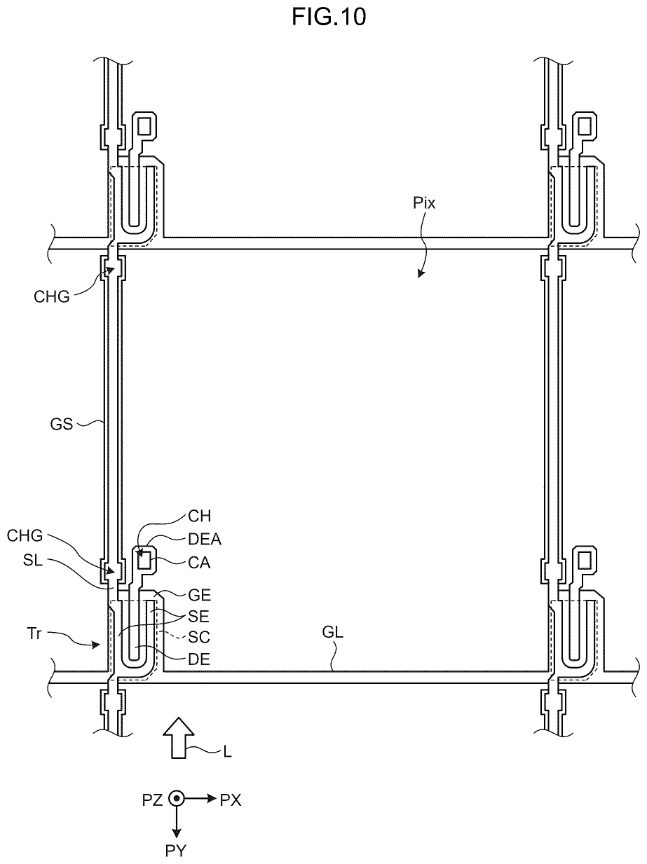

FIG. 10 is a plan view illustrating the scan lines, the signal lines, and the switching element in the pixel. As illustrated in FIGS. 1, 2, and 10, the array substrate 10 is provided with the signal lines SL and the scan lines GL so as to form a grid in plan view. In other words, one surface of the array substrate 10 is provided with the signal lines arranged in the first direction PX with gaps interposed therebetween and the scan lines arranged in the second direction PY with gaps interposed therebetween.

As illustrated in FIG. 10, an area surrounded by the adjacent scan lines GL and the adjacent signal lines SL corresponds to the pixel Pix. The pixel Pix is provided with the pixel electrode PE and the switching element Tr illustrated in FIGS. 8 and 9. In the present embodiment, the switching element Tr is a bottom-gate thin-film transistor. The switching element Tr includes a semiconductor layer SC overlapping, in plan view, a gate electrode GE electrically coupled to a corresponding one of the scan lines GL.

As illustrated in FIG. 10, the scan lines GL are wiring of a metal such as molybdenum (Mo) or aluminum (Al), a multilayered body of these metals, or an alloy thereof. The signal lines SL are wiring of a metal such as aluminum or an alloy thereof.

As illustrated in FIG. 10, the semiconductor layer SC is provided so as not to protrude from the gate electrode GE in plan view. As a result, the light-source light L traveling toward the semiconductor layer SC from the gate electrode GE side is reflected, and light leakage is less likely to occur in the semiconductor layer SC.

As illustrated in FIG. 5, the light-source light L emitted from the light source 7 is incident in the second direction PY serving as a direction of incidence. The direction of incidence refers to a direction from the second side surface 20D closest to the light source 7 toward the first side surface 20C that is a surface opposite the second side surface 20D. When the direction of incidence of the light-source light L is the second direction PY, the length in the first direction PX of the semiconductor layer SC is smaller than the length in the second direction PY of the semiconductor layer SC. This configuration reduces the length in a direction intersecting the direction of incidence of the light-source light L, and thereby, reduces the effect of light leakage.

As illustrated in FIG. 10, two electrical conductors of a source electrode SE that are the same as the signal line SL extend from the signal line SL in the same layer as that of the signal line SL and in a direction intersecting the signal line SL. With this configuration, the source electrode SE electrically coupled to the signal line SL overlaps one end of the semiconductor layer SC in plan view.

As illustrated in FIG. 10, in plan view, a drain electrode DE is provided in a position between the adjacent electrical conductors of the source electrode SE. The drain electrode DE overlaps the semiconductor layer SC in plan view. A portion of the semiconductor layer SC overlapping neither the source electrode SE nor the drain electrode DE serves as a channel of the switching element Tr. A contact electrode DEA electrically coupled to the drain electrode DE is electrically coupled to the pixel electrode PE illustrated in FIG. 8 or 9 through a contact hole CH.

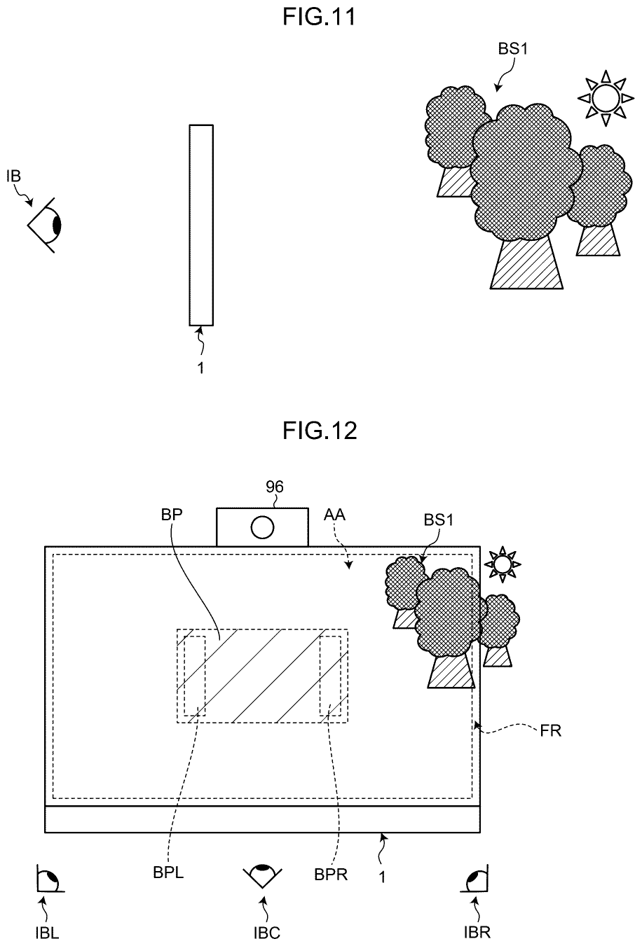

FIG. 11 is an explanatory diagram explaining a relation between the viewer and the background, the viewer viewing the background from one surface side, the background being located on the other surface side opposite to the one surface side. FIG. 12 is an explanatory diagram explaining an example in which the peripheral area overlaps the background. As illustrated in FIG. 11, when a viewer IB views the other surface side of the display device 1 from the one surface side thereof, a background BS1 is viewed through the display device 1. As illustrated in FIG. 12, the viewer IB can view the background BS1 through a portion of the active area AA other than the image BP.

As illustrated in FIG. 12, the viewer IB can view the background BS1 on the other surface side, which is opposite to the one surface side, from the one surface side of the display device 1 also through the peripheral area FR. If the peripheral area FR outside the active area AA does not transmit light, the viewer IB cannot see the background BS1 and may be given a sense of discomfort. Therefore, the display device 1 allows also the peripheral area FR to transmit light so as to make the background BS1 visible, for example, by not forming a light-blocking layer LS that is to be formed on the counter substrate 20. In the display device 1, the peripheral area FR is also a transparent area, in addition to the active area AA (display area).

For example, the imager 96 illustrated in FIG. 12 detects the viewer and transmits the detection result to the mode setter 94 (refer to FIG. 2). If the viewer views the active area AA orthogonally, the mode setter 94 (refer to FIG. 2) sets the mode as a central viewing position IBC. If the viewer views the active area AA from diagonally right of the active area AA, the mode setter 94 (refer to FIG. 2) sets the mode as a right viewing position IBR. If the viewer views the active area AA from diagonally left of the active area AA, the mode setter 94 (refer to FIG. 2) sets the mode as a left viewing position IBL. Instead of setting the mode to the central viewing position IBC, the right viewing position IBR, or the left viewing position IBL based on the information from the imager 96, the mode setter 94 (refer to FIG. 2) may set the mode to the central viewing position IBC, the right viewing position IBR, or the left viewing position IBL based on the information from the input device 95.

In the display device of the first embodiment, as illustrated in FIG. 6, the light source control circuit 32 (refer to FIG. 2) brings at least one of the light emitters 31 in a first area LB1 of the active light-emitting area AAA into a light-emitting state and at least one of the light emitters 31 in a second area LB2 of the active light-emitting area AAA into a non-light-emitting state. The first area LB1 is an area corresponding to the image BP in the second direction PY, and the second area LB2 is an area corresponding to a portion in the second direction PY where the image BP is not displayed.

This configuration improves the contrast of the portion of the image BP with respect to the active area AA where the image BP is not displayed (see-through portion). A central portion in the first direction PX of the first area LB1 is referred to as a central area LB1M of the first area LB1. The area of the first area LB1 on one end side of the central area LB1M in the first direction PX is referred to as a right area LB1R, and the area of the first area LB1 on the other end side of the central area LB1M in the first direction PX is referred to as a left area LB1L. The area of the second area LB2 adjacent to one end of the first area LB1 in the first direction PX is referred to as a first adjacent area LB2R, and the area of the second area LB2 adjacent to the other end of the first area LB1 in the first direction PX is referred to as a second adjacent area LB2L.

When the light emitters 31 in the second area LB2 corresponding to a portion in the second direction PY where the image BP is not displayed are in the non-light-emitting state, the degrees of visibility of the active area AA and the peripheral area FR in each of which the image BP is not displayed are at the same level, making it harder to cause discomfort to the viewer IB.

When the light emitters 31 in the second area LB2 are in the non-light-emitting state, the amount of light may be insufficient at ends of the image BP. The insufficiency of the amount of light is difficult to occur at ends of the image BP for the viewer in the central viewing position IBC who orthogonally views the image BP. However, the amount of light tends to be insufficient at a left end BPL of the image BP, if the viewer is in the right viewing position IBR where the image BP is viewed from diagonally right. The amount of light tends to be insufficient at a right end BPR of the image BP, if the viewer is in the left viewing position IBL where the image BP is viewed from diagonally left.

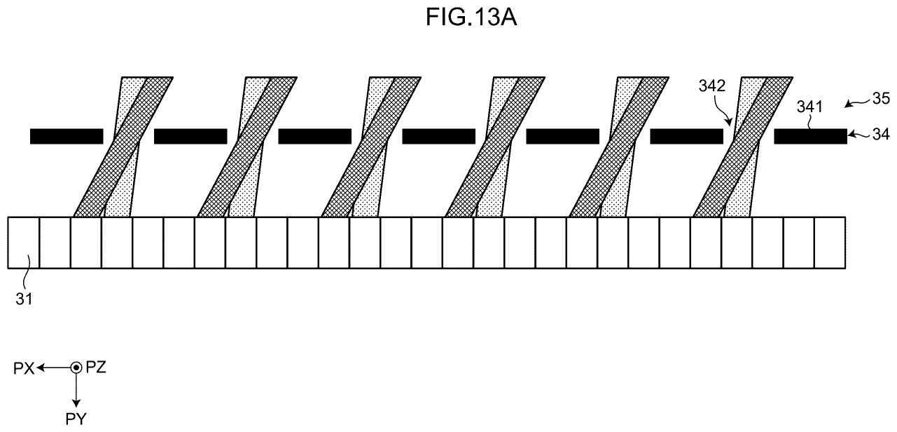

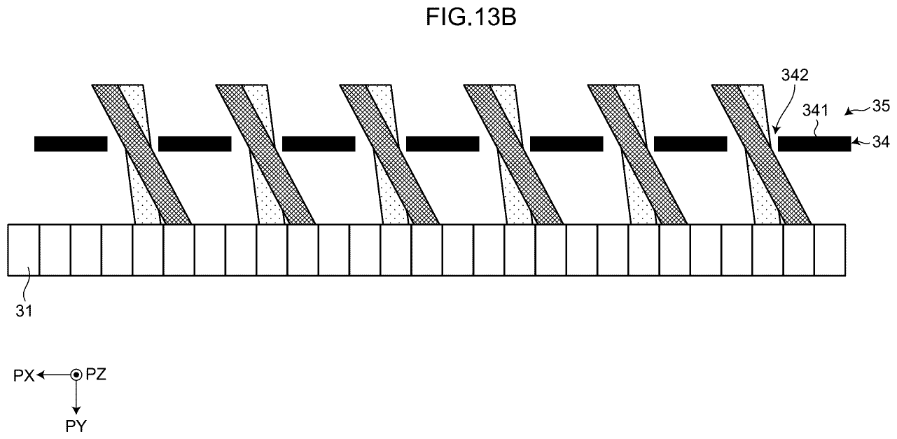

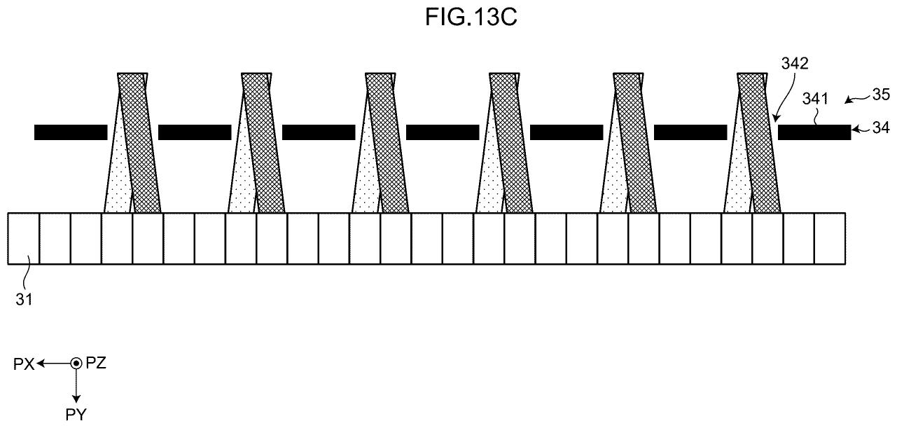

FIGS. 13A, 13B, and 13C are schematic diagrams for explaining the light source of the first embodiment. The light source control circuit 32 (illustrated in FIG. 2) can change the direction of an intensity peak of the light emitted from the light-emitting module 35 with respect to the direction PY to one of states illustrated in FIGS. 13A, 13B, and 13C. As illustrated in FIGS. 13A, 13B, and 13C, the optical member 34 includes a barrier including a light-blocking layer 341 and a plurality of openings 342 provided in the light-blocking layer 341. The openings 342 have slit shapes parallel to the third direction PZ. FIGS. 13A, 13B, and 13C illustrate emitted light for the light emitters 31 that are emitting light and do not illustrate emitted light for the light emitters that are not emitting light.

As illustrated in FIG. 13A, in a light-emitting state where the light emitters 31 facing the openings of the optical member 34 and the light emitters 31 each adjacent to one side of the corresponding one of the openings of the optical member 34 in the PX direction (left side of FIG. 13A) emit light, the direction of the intensity peak of the emitted light tilts rightward with respect to the PY direction.

As illustrated in FIG. 13B, in a light-emitting state where the light emitters 31 facing the openings of the optical member 34 and the light emitters 31 each adjacent to the other side of the corresponding one of the openings of the optical member 34 in the PX direction (right side of FIG. 13B) emit light, the direction of the intensity peak of the emitted light tilts leftward with respect to the PY direction.

As illustrated in FIG. 13C, in a light-emitting state where only the light emitters 31 facing the openings of the optical member 34 emit light, the direction of the intensity peak of the emitted light is the PY direction. Therefore, if the mode is set to the right viewing position IBR (refer to FIG. 12), the light source control circuit 32 (refer to FIG. 2) brings the light emitters 31 in the first area LB1 (refer to FIG. 6) into the light-emitting state illustrated in FIG. 13A. This operation increases the intensity peak of the light emitted toward the viewer in the right viewing position IBR and increases the amount of light at the left end BPL of the image BP.

If the mode is set to the left viewing position IBL (refer to FIG. 12), the light source control circuit 32 (refer to FIG. 2) brings the light emitters 31 in the first area LB1 (refer to FIG. 6) into the light-emitting state illustrated in FIG. 13B. This operation increases the intensity peak of the light emitted toward the viewer in the left viewing position IBL and increases the amount of light at the right end BPR of the image BP.

Furthermore, if the mode is set to the central viewing position IBC, the light source control circuit 32 (refer to FIG. 2) brings the light emitters 31 in the first area LB1 (refer to FIG. 6) into the light-emitting state illustrated in FIG. 13C. This operation increases the intensity peak of the light emitted toward the viewer in the central viewing position IBC and makes the amount of light of the image BP difficult to become insufficient.

As described above, the display device 1 of the first embodiment includes the display panel 2 and the light source 7. The display panel 2 includes the array substrate 10, the counter substrate 20, and the liquid crystal layer 50. The display panel 2 has the active area AA and the peripheral area FR outside the active area AA as viewed in the third direction PZ. The light source 7 includes the light guide 36 and the light emitters 31. The light guide 36 is provided along the second side surface 20D of the counter substrate 20 and the second side surface 25D of the base member 25 along the first direction PX, and the light emitters 31 are arranged so as to face the light guide 36 and arrayed in the first direction PX.

The light source control circuit 32 (refer to FIG. 2) performs control to change the light emission ratio between the light emitters 31 facing the openings of the optical member 34 and the light emitters 31 facing the light-blocking layer of the optical member 34. This operation changes the direction of the intensity peak of the emitted light with respect to the second direction PY depending on the selection from the light-emitting states illustrated in FIGS. 13A, 13B, and 13C.

The light source control circuit 32 (refer to FIG. 2) may perform other control to change the light emission ratio between the light emitters 31 facing the openings of the optical member 34 and the light emitters 31 facing the light-blocking layer of the optical member 34.

For example, as a first modification of the first embodiment, if the mode is set to the right viewing position IBR (refer to FIG. 12), the light source control circuit 32 (refer to FIG. 2) brings the light emitters 31 in the central area LB1M and the right area LB1R (refer to FIG. 6) into the light-emitting state illustrated in FIG. 13C, and the light emitters 31 in the left area LB1L (refer to FIG. 6) into the light-emitting state illustrated in FIG. 13A. This operation increases the intensity peak of the light emitted toward the viewer in the right viewing position IBR and increases the amount of light at the left end BPL of the image BP (refer to FIG. 12). If the mode is set to the left viewing position IBL (refer to FIG. 12), the light source control circuit 32 (refer to FIG. 2) brings the light emitters 31 in the central area LB1M and the left area LB1L (refer to FIG. 6) into the light-emitting state illustrated in FIG. 13C, and the light emitters 31 in the right area LB1R (refer to FIG. 6) into the light-emitting state illustrated in FIG. 13B. This operation increases the intensity peak of the light emitted toward the viewer in the left viewing position IBL (refer to FIG. 12) and increases the amount of light at the right end BPR of the image BP (refer to FIG. 12).

For example, as a second modification of the first embodiment, if the mode is set to the right viewing position IBR (refer to FIG. 12), the light source control circuit 32 (refer to FIG. 2) brings the light emitters 31 in the first area LB1 (refer to FIG. 6) into the light-emitting state illustrated in FIG. 13C, and the light emitters 31 in the second adjacent area LB2L (refer to FIG. 6) into the light-emitting state illustrated in FIG. 13A. This operation increases the intensity peak of the light emitted toward the viewer in the right viewing position IBR and increases the amount of light at the left end BPL of the image BP (refer to FIG. 12). If the mode is set to the left viewing position IBL (refer to FIG. 12), the light source control circuit 32 (refer to FIG. 2) brings the light emitters 31 in the first area LB1 (refer to FIG. 6) into the light-emitting state illustrated in FIG. 13C, and the light emitters 31 in the first adjacent area LB2R into the light-emitting state illustrated in FIG. 13B. This operation increases the intensity peak of the light emitted toward the viewer in the left viewing position IBL (refer to FIG. 12) and increases the amount of light at the right end BPR of the image BP (refer to FIG. 12).

When the image BP is displayed over the entire active area AA, the active light-emitting area AAA serves as the first area LB1 and the peripheral light-emitting area FRA serves as the second area LB2. The peripheral area FR may be said to be included in the second area LB2. If the mode is set to the right viewing position IBR (refer to FIG. 12), the light source control circuit 32 (refer to FIG. 2) brings the light emitters 31 in the active light-emitting area AAA (refer to FIG. 6) into the light-emitting state illustrated in FIG. 13C, and the light emitters 31 in the left side peripheral light-emitting area FRA (refer to FIG. 6) into the light-emitting state illustrated in FIG. 13A. This operation increases the intensity peak of the light emitted toward the viewer in the right viewing position IBR and increases the amount of light at the left end BPL of the image BP (refer to FIG. 12). If the mode is set to the left viewing position IBL (refer to FIG. 12), the light source control circuit 32 (refer to FIG. 2) brings the light emitters 31 in the active light-emitting area AAA (refer to FIG. 6) into the light-emitting state illustrated in FIG. 13C, and the light emitters 31 in the right side peripheral light-emitting area FRA (refer to FIG. 6) into the light-emitting state illustrated in FIG. 13B. This operation increases the intensity peak of the light emitted toward the viewer in the left viewing position IBL (refer to FIG. 12) and increases the amount of light at the right end BPR of the image BP (refer to FIG. 12).

### Second Embodiment

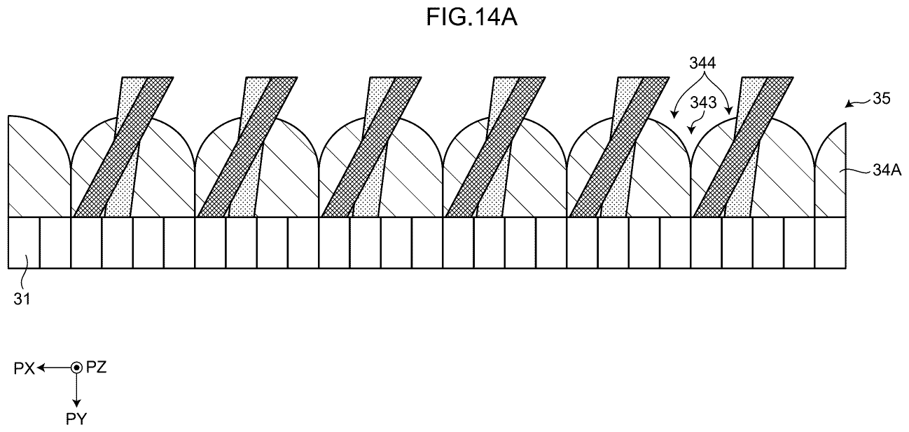

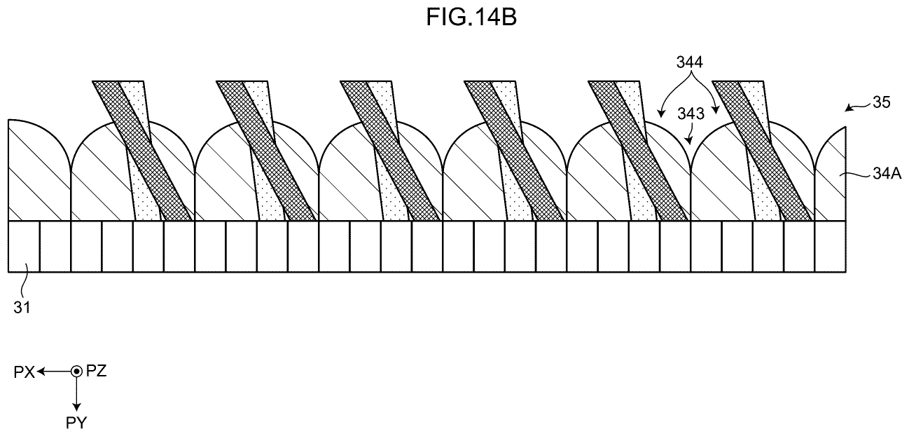

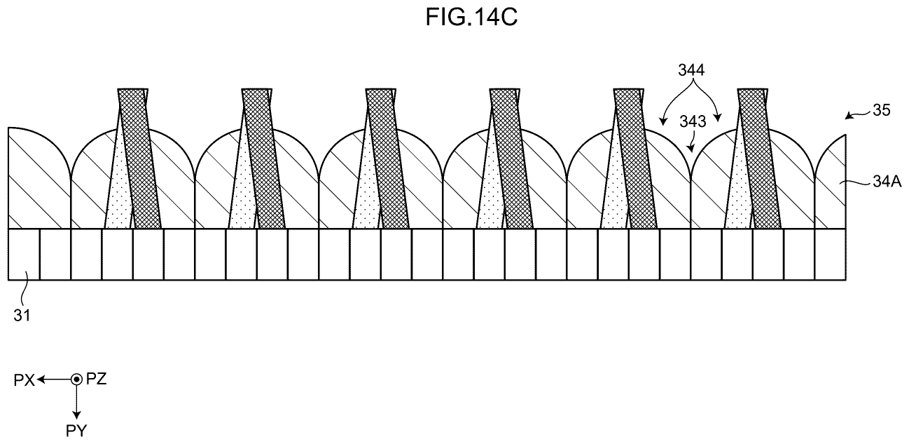

FIGS. 14A, 14B, and 14C are schematic diagrams for explaining a light source of a second embodiment of the present disclosure. The same components as those described in the embodiment above are denoted by the same reference numerals, and the description thereof will not be repeated.

The light-emitting module 35 of the second embodiment includes the light emitters 31 and an optical member 34A. As illustrated in FIGS. 14A, 14B, and 14C, the optical member 34A includes a lens provided with a plurality of concavities 343 and a plurality of convexities 344 that are arranged alternately along the first direction PX. The convexities 344 extend parallel to the third direction PZ. The light source control circuit 32 (illustrated in FIG. 2) can change the direction of the intensity peak of the light emitted from the light-emitting module 35 with respect to the direction PY to one of states illustrated in FIGS. 14A, 14B, and 14C. FIGS. 14A, 14B, and 14C illustrate emitted light for the light emitters 31 that are emitting light and do not illustrate emitted light for the light emitters 31 that are not emitting light.

As illustrated in FIG. 14A, when the light emitters 31 facing the convexities 344 of the optical member 34A and the light emitters 31 each adjacent to one side of the corresponding one of the tops of the convexities 344 of the optical member 34A in the PX direction (left side of FIG. 14A) emit light, the direction of the intensity peak of the emitted light tilts rightward with respect to the PY direction.

As illustrated in FIG. 14B, when the light emitters 31 facing the convexities 344 of the optical member 34 and the light emitters 31 each adjacent to the other side of the corresponding one of the tops of the convexities 344 of the optical member 34A in the PX direction (right side of FIG. 14B) emit light, the direction of the intensity peak of the emitted light tilts leftward with respect to the PY direction.

As illustrated in FIG. 14C, when only the light emitters 31 facing the tops of the convexities 344 of the optical member 34A emit light, the direction of the intensity peak of the emitted light is the PY direction.

Therefore, if the mode is set to the right viewing position IBR (refer to FIG. 12), the light source control circuit 32 (refer to FIG. 2) brings the light emitters 31 in the first area LB1 (refer to FIG. 6) into the light-emitting state illustrated in FIG. 14A. This operation increases the intensity peak of the light emitted toward the viewer in the right viewing position IBR and increases the amount of light at the left end BPL of the image BP.

If the mode is set to the left viewing position IBL (refer to FIG. 12), the light source control circuit 32 (refer to FIG. 2) brings the light emitters 31 in the first area LB1 (refer to FIG. 6) into the light-emitting state illustrated in FIG. 14B. This operation increases the intensity peak of the light emitted toward the viewer in the left viewing position IBL and increases the amount of light at the right end BPR of the image BP.

Furthermore, if the mode is set to the central viewing position IBC, the light source control circuit 32 (refer to FIG. 2) brings the light emitters 31 in the first area LB1 (refer to FIG. 6) into the light-emitting state illustrated in FIG. 14C. This operation increases the intensity peak of the light emitted toward the viewer in the central viewing position IBC and makes the amount of light of the image BP difficult to become insufficient.

As described above, the light source control circuit 32 (refer to FIG. 2) performs control to change the light emission ratio between the light emitters 31 facing the convexities 344 of the optical member 34A and the light emitters 31 adjacent to the tops of the convexities 344 of the optical member 34A. This operation changes the direction of the intensity peak of the emitted light with respect to the second direction PY, as illustrated in FIGS. 14A, 14B, and 14C.

The light emitter 31 of the second embodiment also includes the three light-emitting elements 33R, 33G, and 33B that can emit different colors, and the light emitter 31 emits light in different colors in a time-division manner.

### Third Embodiment

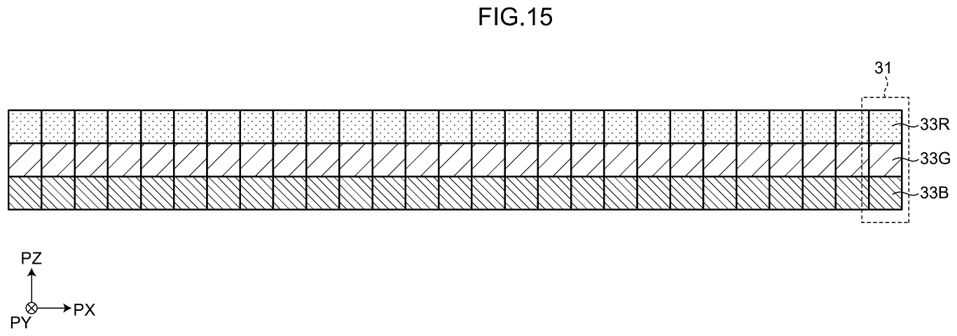

FIG. 15 is a plan view for explaining a light source of a third embodiment of the present disclosure. The same components as those described in the embodiments above are denoted by the same reference numerals, and the description thereof will not be repeated.

As illustrated in FIG. 15, in the third embodiment, the light emitter 31 includes the light-emitting elements 33R, 33G, and 33B arranged in the third direction PZ.

The light emitter 31 of the third embodiment also includes the three light-emitting elements 33R, 33G, and 33B that can emit different colors, and the light emitter 31 emits light in different colors in a time-division manner.

### Fourth Embodiment

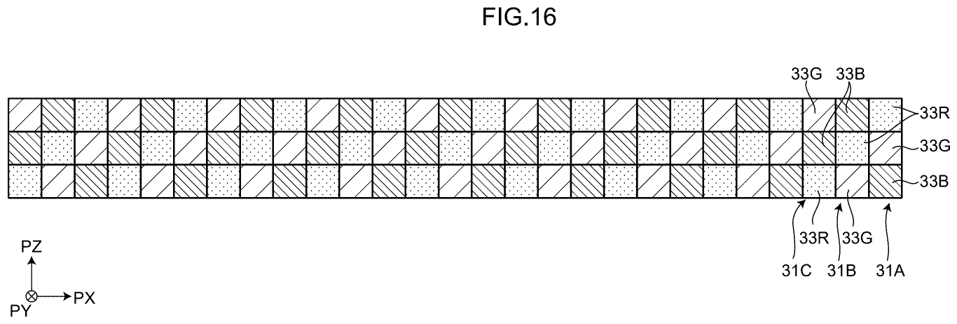

FIG. 16 is a plan view for explaining a light source of a fourth embodiment of the present disclosure. The same components as those described in the embodiments above are denoted by the same reference numerals, and the description thereof will not be repeated.

As illustrated in FIG. 16, in the fourth embodiment, the light emitter 31 includes the light-emitting elements 33R, 33G, and 33B arranged in the third direction PZ. The light-emitting elements 33R, 33G, and 33B are also arranged in sequence in the first direction PX. The light source of the fourth embodiment has a smaller variation in color in the third direction PZ than the light source of the third embodiment.

The light emitter 31 of the fourth embodiment also includes the three light-emitting elements 33R, 33G, and 33B that can emit different colors, and the light emitter 31 emits light in different colors in a time-division manner.

### Fifth Embodiment

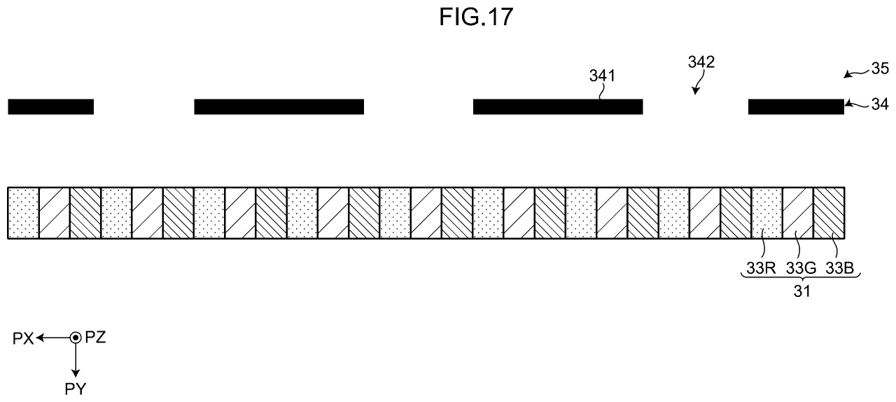

FIG. 17 is a sectional view illustrating an example of a section of a light source of a fifth embodiment of the present disclosure. The same components as those described in the embodiments above are denoted by the same reference numerals, and the description thereof will not be repeated.

As illustrated in FIG. 17, in the fifth embodiment, the light emitter 31 includes one of the light-emitting elements 33R, 33G, and 33B in the third direction PZ, and the light-emitting elements 33R, 33G, and 33B are sequentially arranged in the first direction PX.

The light emitter 31 of the fifth embodiment also includes the three light-emitting elements 33R, 33G, and 33B that can emit different colors, and the light emitter 31 emits light in different colors in a time-division manner.

While the preferred embodiments have been described above, the present disclosure is not limited to such an embodiments. The content disclosed in the embodiments is merely an example and can be variously modified within the scope not departing from the gist of the present disclosure. Any modification appropriately made within the scope not departing from the gist of the present disclosure also naturally belongs to the technical scope of the present disclosure.

In addition, a direct-current voltage may be supplied as the common potential. That is, the common potential may be constant. Alternatively, an alternating-current voltage may be supplied as the common potential. That is, the common potential may have two values of an upper limit value and a lower limit value. Whether the common potential is a direct-current potential or an alternating-current potential, the common potential is supplied to the holding capacitance electrode IO and the common electrode CE.

What is claimed is:

1. A display device comprising:
a display panel that comprises a first light-transmitting substrate, a second light-transmitting substrate, and a liquid crystal layer between the first light-transmitting substrate and the second light-transmitting substrate, and has an active area capable of displaying images and a peripheral area outside the active area as viewed in a direction orthogonal to the first light-transmitting substrate;
a light-transmitting glass base member bonded to the display panel;
a light source disposed so as to emit light into a side surface of the first light-transmitting substrate, a side surface of the second light-transmitting substrate, or a side surface of the glass base member; and
a light source control circuit configured to control the light source, wherein
the light source comprises a plurality of light emitters arranged in a first direction along the side surface of the first light-transmitting substrate, the side surface of the second light-transmitting substrate, or the side surface of the glass base member,
the light source control circuit is configured to bring at least one of the light emitters in a first area into a light-emitting state and bring at least one of the light emitters in a second area other than the first area into a non-light-emitting state, and
the first area is an area that overlaps an area obtained by extending an image area including an image in the active area in a second direction orthogonal to the first direction.

2. The display device according to claim 1, wherein the light source control circuit is capable of changing a direction of an intensity peak of light emitted from the light source with respect to the second direction.

3. The display device according to claim 1, wherein the light source comprises a barrier comprising a light-blocking layer in which a plurality of openings are provided.

4. The display device according to claim 3, wherein the light source control circuit is configured to perform control to change a light emission ratio between the light emitters facing the openings and the light emitters facing the light-blocking layer.

5. The display device according to claim 1, comprising a lens provided with a plurality of concavities and a plurality of convexities that are arranged alternately along the first direction.

6. The display device according to claim 5, wherein the light source control circuit is configured to perform control to change a light emission ratio of the light emitters that emit light among the light emitters adjacent to tops of the convexities.

7. The display device according to claim 1, wherein each of the light emitters comprises three light-emitting elements capable of emitting different colors, and the light emitter is configured to emit light in different colors in a time-division manner.

8. The display device according to claim 1, wherein each of the light emitters comprises three light-emitting elements capable of emitting different colors, and the light-emitting elements adjacent to each other in the first direction are capable of emitting different colors.

9. The display device according to claim 7, wherein the light emitter comprises three light-emitting elements that are capable of emitting different colors and provided along a third direction orthogonal to the first direction and the second direction, and the light-emitting elements adjacent to each other in the third direction are capable of emitting different colors.

10. The display device according to claim 1, wherein, in areas other than the image area, a background of the second light-transmitting substrate is visible from the first light-transmitting substrate, and a background of the first light-transmitting substrate is visible from the second light-transmitting substrate.

11. The display device according to claim 1, wherein
the liquid crystal layer is polymer-dispersed liquid crystals,
the first light-transmitting substrate has a first principal surface and a second principal surface that is a flat surface parallel to the first principal surface,
the second light-transmitting substrate has a first principal surface and a second principal surface that is a flat surface parallel to the first principal surface, and
when the polymer-dispersed liquid crystals are in a non-scattering state, a background on a first principal surface side of the second light-transmitting substrate is visible from the first principal surface of the first light-transmitting substrate, or a background on a first principal surface side of the first light-transmitting substrate is visible from the first principal surface of the second light-transmitting substrate.
